(19) United States
(12) Patent Application Publication
(10) Pub. No.: US 2025/0383759 A1
(43) Pub. Date: Dec. 18, 2025

(54) VIRTUAL PET FEATURES WITHIN A MAP

(71) Applicant: Snap Inc., Santa Monica, CA (US)

(72) Inventor: Suraya Shivji, New York, NY (US)

(21) Appl. No.: 18/744,395

(22) Filed: Jun. 14, 2024

(51) Int. Cl. G06F 3/0484; G06T 13/80

(52) U.S. Cl. CPC G06F 3/0484; G06T 13/80; G06T 2200/24

(57) ABSTRACT

Described is a system for feeding pet avatars by accessing a particular geographic location for a first user; accessing map data for the particular geographic location; identifying that a pet avatar for a second user is associated with the particular geographic location; causing display, on a first computing device of the first user, of: the particular geographic location using the map data; the pet avatar; and an interface element configured to feed the pet avatar; receiving a user selection of the interface element from the first user; causing display, on the first computing device for the first user, of an indication of the pet avatar being fed corresponding to the interface element; and transmitting a notification to a second computing device of the second user including an indication that the pet avatar is being fed corresponding to the interface element.

### TECHNICAL FIELD

The present disclosure relates generally to virtual pet features, in particular, virtual pet features within a virtual map.

### BACKGROUND

As the popularity of online mobile applications grows, companies use data analysis techniques to provide recommended content to users. These recommendations aim to provide the most value to users by showing them content that is relevant and interesting to them. Subject to regulations and privacy laws worldwide, companies collect vast amounts of data from users, including their interests, demographic information, browsing history, likes, shares, comments, and connections with other users. Based on the collected data, companies create a user profile that is used to identify relevant content on their platforms. Companies may also employ natural language processing and image recognition techniques to better understand the content.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system that has both client-side and server-side functionality, according to some examples.

FIG. 3 is a diagrammatic representation of a data structure as maintained in a database, according to some examples.

FIG. 4 illustrates an example method for feeding a friend's pet, according to some examples.

FIG. 5 illustrates an example of a user interface that enables a user to add an object to their own avatar, according to some examples.

FIG. 6 illustrates an example user interface enabling a user to select among a plurality of animal types for his or her pet avatar, according to some examples

FIG. 7 illustrates an example of setting a location for a pet avatar, according to some examples.

FIG. 8 illustrates a street view of the location set for the pet avatar, according to some examples.

FIG. 9 illustrates a display for a first user of a particular geographic location with a user's pet avatar, according to some examples.

FIG. 10 illustrates multiple user interface options for the first user to interact with the second user's pet, according to some examples.

FIG. 11 illustrates a user interface displaying visual effects of falling food items to indicate feeding of the pet, according to some examples.

FIG. 12 illustrates an example of a notification that is transmitted to the second user indicating that the second user's pet is being fed by the first user, according to some examples.

FIG. 13 illustrates an example of stretching and squashing an image to indicate an action of the pet avatar, according to some examples.

FIG. 14 is a diagrammatic representation of a message, according to some examples.

FIG. 15 illustrates a system including a head-wearable apparatus with a selector input device, according to some examples.

FIG. 16 is a diagrammatic representation of a machine in the form of a computer system within which a set of instructions may be executed to cause the machine to perform any one or more of the methodologies discussed herein, according to some examples.

FIG. 17 is a block diagram showing a software architecture within which examples may be implemented.

FIG. 18 illustrates a machine-learning pipeline, according to some examples.

FIG. 19 illustrates training and use of a machine-learning program, according to some examples.

### DETAILED DESCRIPTION

Traditional systems often fall short in providing the level of engagement and interactivity that our system achieves with pet feeding. Traditional systems typically use static avatars that do not respond dynamically to user interactions. This lack of movement and response can make the virtual pets seem lifeless and unengaging.

If animations are present, they are often limited to pre-rendered sequences that do not adapt to different types of interactions or feeding events, leading to repetitive and predictable user experiences.

Traditional systems usually provide generic responses that do not account for the specific actions taken by the user. For example, feeding a pet might always trigger the same canned animation regardless of the food type, failing to create a sense of personalization or uniqueness. Users also cannot customize or influence the behavior and appearance of their virtual pets based on their interactions, leading to a lack of personal connection and engagement.

Traditional systems often lack real-time feedback mechanisms. When users feed their pets, they may not receive immediate visual or auditory confirmation of the action, leading to a disconnect between the user's actions and the pet's responses. The absence of timely notifications to the second user about their pet's interactions can result in missed opportunities for engagement and communication between users.

Traditional systems offer limited options for interacting with virtual pets. Users might only have a few predefined actions they can perform, reducing the novelty and excitement of the interactions. Without a variety of interaction elements (e.g., different types of food, toys, or actions), the user experience can quickly become monotonous.

Traditional systems often do not integrate well with the user's context, such as geographic location or usage patterns. This lack of contextual awareness means that interactions feel disconnected from the user's real-world environment and activities. The pet's environment and behavior remain static, failing to adapt to changes in the user's location or activity, which limits the sense of a dynamic and evolving relationship with the virtual pet.

Traditional systems that do include more advanced animations often rely on resource-intensive processes that can slow down the application and affect overall performance, especially on lower-end devices. These heavy animations can lead to lag, longer load times, and a less responsive user experience, which detracts from user engagement.

Many traditional systems do not facilitate meaningful social interactions between users through their virtual pets. There is often no mechanism for users to interact with each other's pets in real-time or receive notifications about these interactions. The lack of shared experiences and feedback between users diminishes the potential for community-building and social engagement within the app.

Traditional systems rarely leverage advanced technologies like generative AI to create dynamic and personalized pet avatars. This results in a more static and less engaging experience. Content and interactions are often predefined and lack the adaptability and creativity that generative AI can offer, limiting the system's ability to surprise and delight users.

By addressing these pitfalls, the interaction system offers a more engaging and interactive experience through dynamic pet avatars that respond in real-time to user actions, personalized animations, and a variety of interaction options that create a rich and immersive virtual environment.

The interaction system overcomes the pitfalls of traditional systems by providing a highly engaging and interactive user experience through dynamic and responsive features. Unlike static avatars in traditional systems, the interaction system uses dynamic animations that respond in real-time to user interactions. When a user feeds their pet, the avatar performs specific actions like chewing, tail wagging, or expressing satisfaction, creating a lively and engaging experience.

By employing animation techniques such as stretching and squashing, the interaction system can simulate realistic movements without needing to render new images, making the interactions feel natural and fluid.

The interaction system personalizes the pet's responses based on the type of food given. For example, feeding the pet meat consistently can lead to muscle-building transformations, while feeding it junk food might make it chubbier. These transformations are driven by generative AI, which adapts the pet's appearance and behavior over time based on user interactions.

Users can provide input to customize their pet's characteristics and personality traits, resulting in a unique and personalized virtual pet experience that evolves with their interactions.

The interaction system ensures that users receive immediate feedback when they feed their pet. This could include animations of the pet eating, visual effects like sparkles, and auditory cues like munching sounds. Real-time notifications keep the user engaged and aware of their pet's status. When one user feeds another's pet, the second user receives a real-time notification, enhancing engagement and social interaction between users.

The interaction system offers a wide range of interaction options, such as different types of food items (pizza, candy, meat) and various icons (hand, heart, plus) to interact with both the user and the pet avatars. This variety keeps the interactions fresh and exciting. The interface includes multiple icons above the avatars, allowing users to perform different actions like waving, liking, or adding new elements, providing a richer interaction palette.

The interaction system is aware of the user's geographic location and integrates this context into the pet interactions. For instance, a user can search for a specific area like Tribeca and see other users' pets in that location, fostering a sense of community and relevance. The pet's environment can change based on the user's location or activity, making the virtual world feel more dynamic and connected to the real world.

By using techniques like stretch and squash, the interaction system avoids the need for resource-intensive animations, ensuring smooth performance even on lower-end devices. This optimizes the user experience without compromising on visual quality. The interaction system is designed to be lightweight and efficient, avoiding the lag and performance issues common in traditional systems with heavy animations.

The interaction system encourages social interactions by allowing users to feed each other's pets and receive notifications about these actions. This fosters a sense of community and makes the experience more engaging. Users can share their pet's transformations and feeding interactions with friends, creating opportunities for social engagement and community building within the app.

The interaction system leverages generative AI to create dynamic and personalized pet avatars. This AI-driven approach allows for continuous evolution and customization of the pet's appearance and behavior based on user interactions. Generative AI enables our system to produce new and varied content, ensuring that the user experience remains fresh and captivating over time.

By addressing these pitfalls, our pet feeding system delivers a highly engaging, personalized, and interactive experience that far surpasses the limitations of traditional systems. This not only enhances user satisfaction but also fosters a deeper emotional connection between users and their virtual pets.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in an pet avatar process. Computing resources used by one or more machines, databases, or networks may thus be more efficiently utilized or even reduced.

### Networked Computing Environment

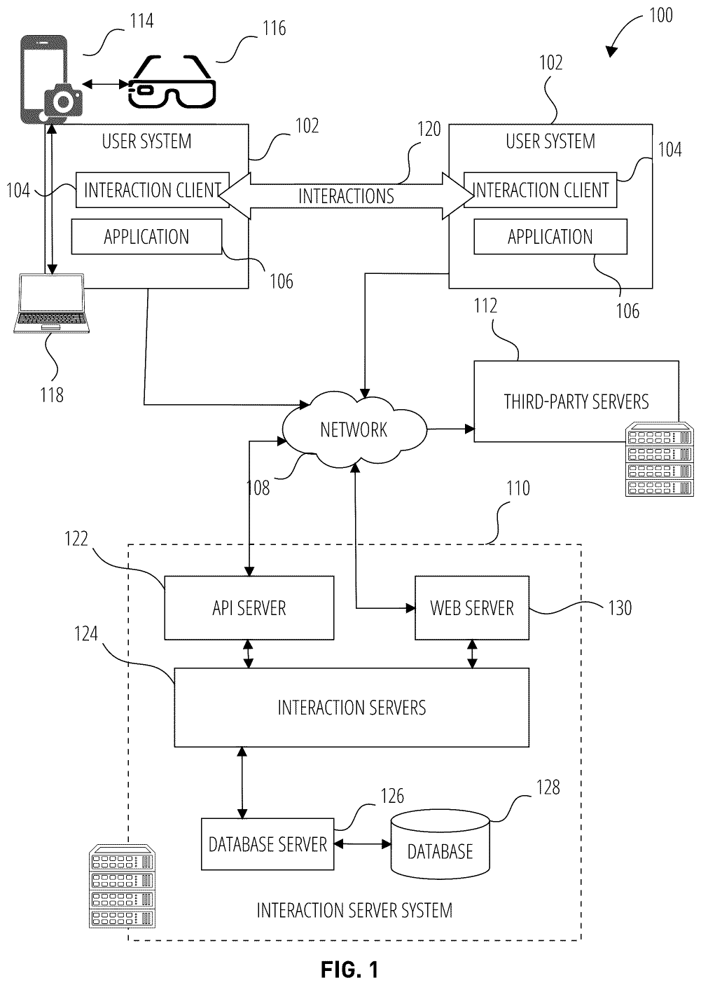

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Programming Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the other interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an API server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

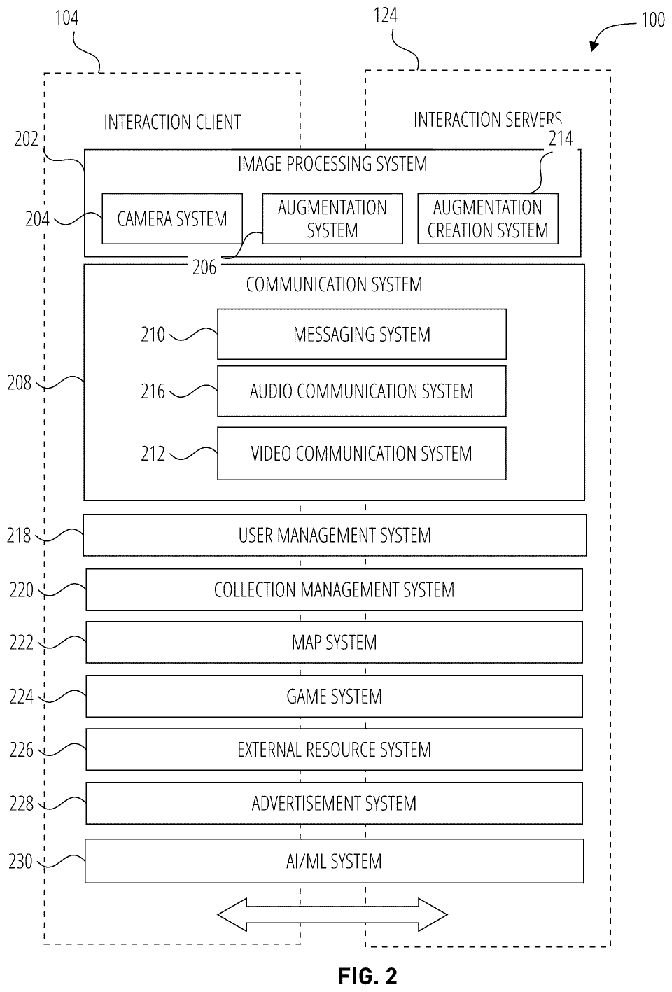

The interaction servers 124 hosts multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from third-party servers 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different applications 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of a microservice subsystem may include:
Function logic: The function logic implements the functionality of the microservice subsystem, representing a specific capability or function that the microservice provides.
API interface: Microservices may communicate with other component through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1502 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports AR developer platforms and includes an application for content creators (e.g., artists and developers) to create and publish augmentations (e.g., AR experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes APIs with functions that can be called or invoked by the web-based application. The interaction servers 124 hosts a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another GUI of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

### Data Architecture

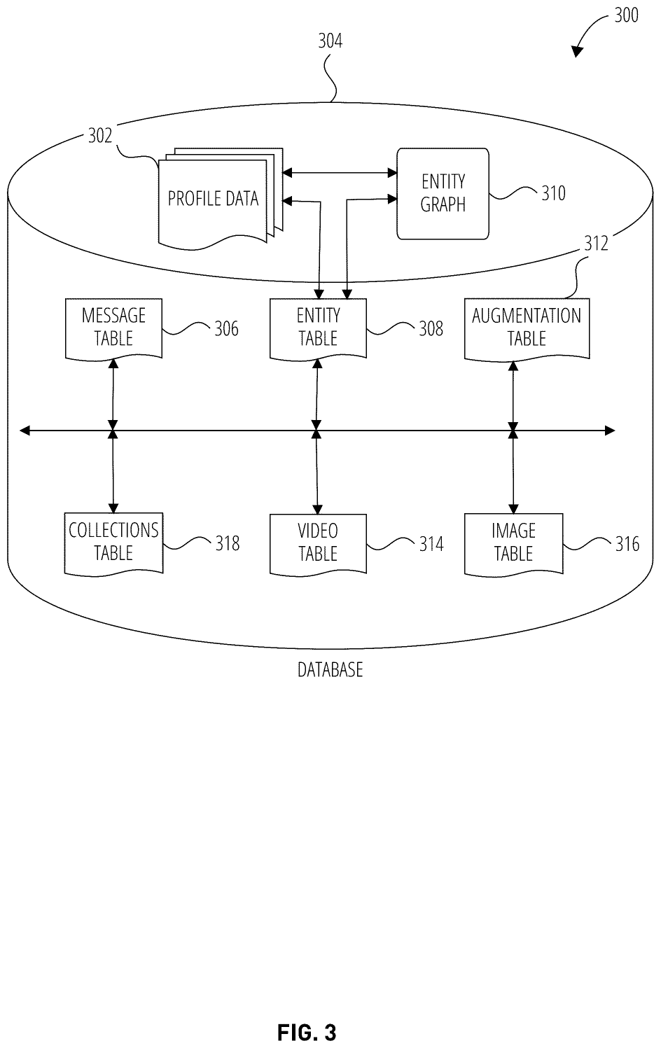

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database). In some cases, the database 304 includes features of or corresponds to database 128 in FIG. 1, and/or vice versa.

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100. A friend relationship can be established by mutual agreement between two entities. This mutual agreement may be established by an offer from a first entity to a second entity to establish a friend relationship, and acceptance by the second entity of the offer for establishment of the friend relationship.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes AR content items (e.g., corresponding to applying “lenses” or AR experiences). An AR content item may be a real-time special effect and sound that may be added to an image or a video.

### Feeding a Friend's Pet

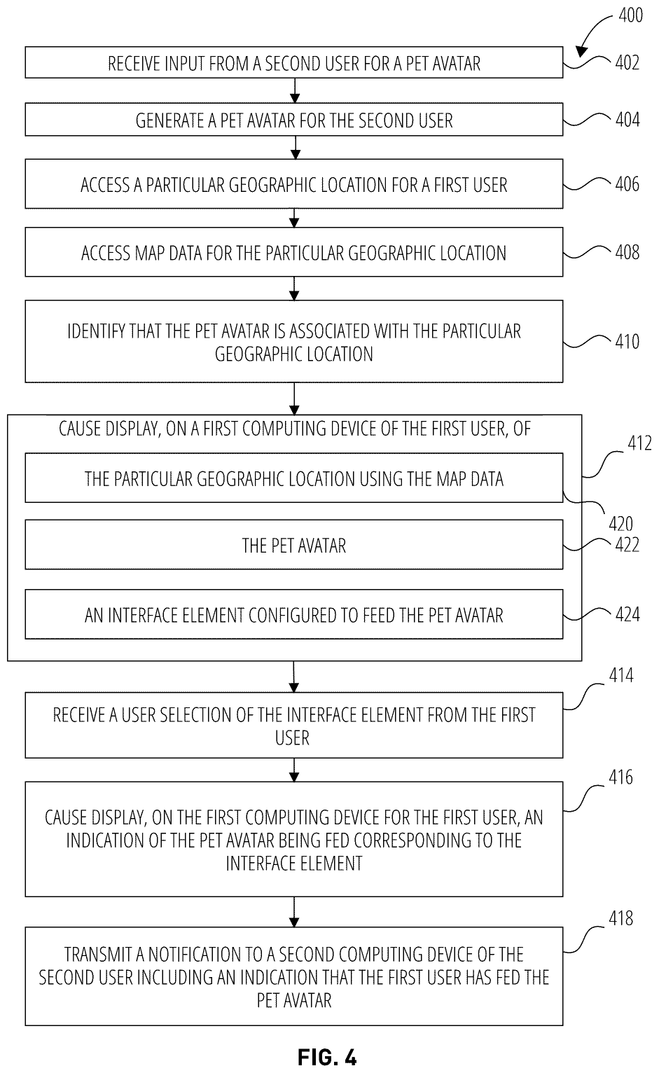

FIG. 4 illustrates an example method 400 for feeding a friend's pet, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Although examples described herein describe a pet avatar, it is appreciated that other objects are within the spirit of the disclosure. For example, a car avatar can be fed turbo nitrous gas to transform into a race car, or furniture can be fed steel to turn into a larger piece of durable furniture.

Although examples are described as being performed by certain systems or applying certain processes, such as a particular machine learning model or computer vision model, the processes described herein can be performed by one or more other or the same machine learning models, computer vision models, or a combination thereof.

At operation 402, the interaction system receives input from a second user for a pet avatar. The system can receive various types of input from a second user that are related to a pet avatar. In some cases, the inputs allow the second user to personalize and customize the appearance and characteristics of the pet avatar.

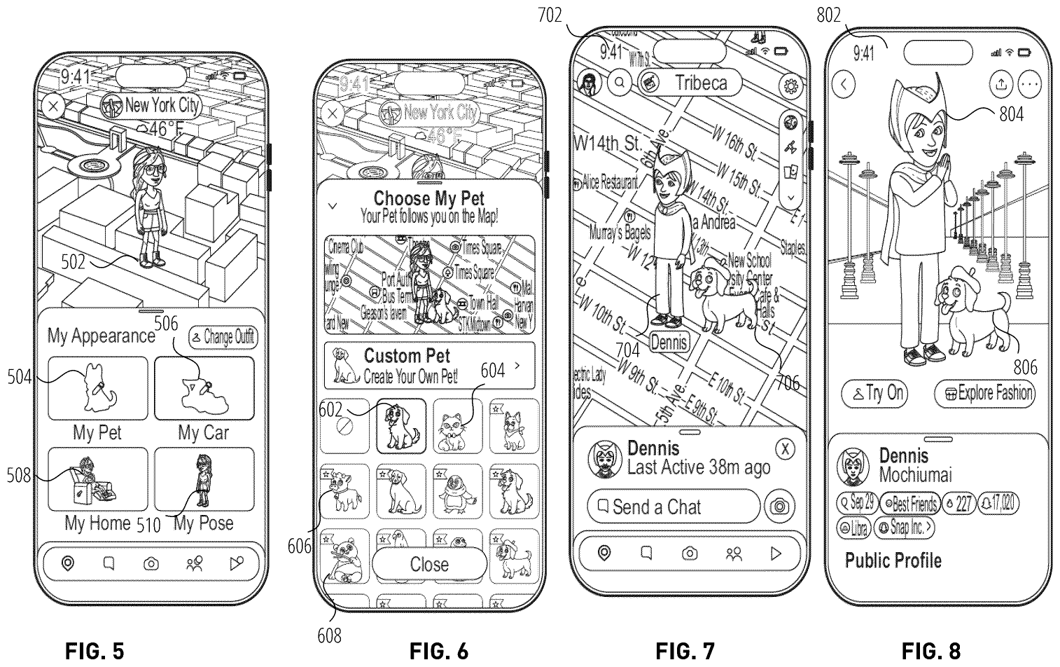

FIG. 5 illustrates an example of a user interface that enables a user to add an object to their own avatar, according to some examples. The user interface displays a user's avatar 502. The user can select to add a pet avatar 504, a car avatar 506, furniture 508, or to change a user avatar's pose 510.

FIG. 6 illustrates an example user interface enabling a user to select among a plurality of animal types for his or her pet avatar, according to some examples. A user can select from a variety of animals as their pet avatar, including options such as a dog 602, cat 604, cow 606, or panda 608. FIG. 6 represents a GUI of an application where a user can browse and select among different types of animals to choose a pet avatar. This provides an intuitive and user-friendly experience, allowing users to easily explore and select their preferred pet.

In some cases, the user can select among different categories of animals (e.g., mammals, birds, reptiles, exotic) to help users navigate through different types of pets. In some cases, the user interface enables a search bar for users to quickly find specific animals by name.

The user can select or modify the pet avatar's appearance, including options for species or breed by choosing the type of pet (e.g., dog, cat, bird) and specific breed. The user can select a color or pattern by selecting colors and patterns for the pet's fur, feathers, or skin. The user can select accessories by adding accessories like collars, hats, clothes, or other decorative items. The user can select a feature, such as modifying features, such as eye shape, ear size, tail length, etc.

The user can select or modify the pet avatar's mood or personality settings by setting the pet's mood (e.g., happy, sad, playful) or personality traits (e.g., friendly, shy, energetic). The user can select actions or animations by choosing specific actions for the pet to perform, such as sitting, jumping, running, or playing. The user can select training commands by providing training inputs to teach the pet avatar new tricks or behaviors (e.g., “sit,” “roll over”).

The user can input interaction data that facilitate direct interaction between the second user and the pet avatar or between the pet avatar and other users or their pets. The user can input interactions related to feeding by selecting food items to feed the pet avatar, playing by choosing toys or activities for the pet avatar to engage in, grooming by performing grooming actions like brushing, bathing, or trimming, or communication by sending messages or commands to the pet avatar, possibly including voice inputs.

The user can input social interaction data involving the pet avatar and other users or their pets. For example, the user can input friend requests by sending or accepting friend requests on behalf of the pet avatar to interact with other pet avatars, gifts or rewards by sending gifts or rewards to other pet avatars, or events or challenges by participating in events, competitions, or challenges with other pet avatars.

The user can input maintenance inputs that involve regular maintenance or health-related actions for the pet avatar. For example, the user can input health checkups by scheduling and performing virtual health checkups or treatments, feeding schedules by setting up regular feeding schedules, or activity monitoring by tracking the pet avatar's activity levels and adjusting routines accordingly.

In a particular example, the second user, Bob provides the following inputs to the interaction system. Bob chooses to customize his pet avatar, changing its breed to a Golden Retriever, selecting a blue collar, and adding a playful personality trait. Bob enables training of his pet avatar to perform a new trick, such as rolling over. Bob enables feeding his pet avatar with pizza and salads, and then enables a toy to play fetch with. Bob sends a friend request to Alice's pet avatar and sends a virtual gift of a new toy. Bob schedules a virtual health checkup and sets up a daily feeding schedule for his pet avatar.

In some cases, the interaction data accesses profile data of the user to determine a customized pet avatar for the user. Profile data of users includes personal information, such as a name, email address, phone number, date of birth, gender, education, occupation, interests, and/or the like. Profile data of users includes profile pictures, cover photos, biographies, and any other customizations made by the user to their online profiles, such as pictures of the pet. The interaction system can perform image recognition to identify characteristics of a real life pet that the user owns.

Profile data of users includes connections and relationships with other users, such as a user's friends, followers, and connections, as well as the groups and pages they follow or like. The interaction system can identify similar characteristics of real life pets or pet avatars owned by their connections.

Profile data of users includes content users share, such as text, photos, videos, and links, and direct messages, comments, and any other interactions users have within the platform. The interaction system can identify characteristics of pets that the user liked in a photograph or video posted by another user.

Profile data of users includes location data, such as the user's city or precise GPS coordinates, such as when using location-based features or when sharing content with location tags. The interaction system can identify characteristics of common pets in a certain area.

Profile data of users includes how users interact with the platform's services, such as the content they view, like, share, or engage with, as well as the features they use and the duration of their sessions. Profile data of users includes data about the devices used to access their services, including device model, operating system, browser type, IP address, and unique identifiers like device IDs or cookies.

In some cases, a machine learning model can access such profile data to identify recommended characteristics of a pet avatar. In some cases, the machine learning model can access a user's interaction with the entire system via interaction functions to create an identity profile. The machine learning model is trained to be able to identify characteristics of a user based on the user's interaction via the interaction functions.

The system determines an initiation of an interaction function by a first user of an interaction system with a second user of the interaction system. In some examples, interaction functions include user interaction with a camera feed displayed on the user system 102, such as selecting a real-world object on a camera feed or selecting a digital item or overlay shown on the camera feed. In some examples, interaction functions also include a chat window where messages, stickers, emojis, and other media content items are shared between users via user systems 102.

Interaction functions further include sending photos or videos to friends, either individually or in groups, which are edited with text, stickers, filters, and drawings before being sent. Interaction functions include capturing a video or audio, inputting text, or other communications that disappear after certain conditions are met, such as being viewed once or setting a time limit, creating a more ephemeral and casual sharing experience.

In some examples, interaction functions include generating or viewing a collection of videos, messages, stickers, or other media content items that are visible to friends for a certain period of hours (e.g., 24 hours). Interaction functions include displaying media content items from other users, such as publishers, creators, and influencers, where users explore and subscribe to different channels to receive updates on their favorite content. Interaction functions include map and location functions, such as users sharing their location with friends and viewing their friends' locations on a map, or exploring a map with points of interest by other users categorized by location and events.

In some examples, interaction functions include generating or applying various filters and content augmentations to enhance images, videos, or other media content items to share with others, such as by adjusting the color or appearance or adding interactive elements such as animations and facial transformations, in real-time. Interaction functions include saving favorite media content items with other users in a private archive, where users access these saved media content items later and edit them or share them with friends.

Interaction functions include personalizing or applying avatars that are used as a profile picture to be viewed by others and in stickers, chat, and image/video decorations. Interaction functions include playing multiplayer games that users play with their friends directly within the user interface of the system to share messages and media content items.

Interaction functions include capturing data by an AR device. In some examples, the interaction system 100 captures motion and position data, such as data from accelerometers, gyroscopes, and magnetometers to track user movement or orientation. In some examples, the interaction system 100 captures eye-tracking data which monitors the user's eye movements and focus, gaze-based interactions, objects the user is focused (or not focused) on, or user attention patterns.

In some examples, the interaction system 100 captures facial expressions. In some examples, the interaction system 100 captures biometric data, such as heart rate, body temperature, or skin conductivity. In some examples, the interaction system 100 captures data related to user interactions within the virtual or augmented environment, such as objects or buttons users interact with, the time spent in specific areas, or the choices users make. In some examples, the interaction system 100 captures voice data, voice recognition, voice commands, and/or the like. In some examples, the interaction system 100 captures location data, such as a user's GPS location. In some examples, the interaction system 100 captures usage data related to how and when the devices are used, session duration, frequency of use, and user engagement with specific content or applications.

At operation 404, the interaction system generates a pet avatar for the second user. The system can generate a virtual pet that reflects the user's personality or pet preferences. For instance, if the interaction system determines that a user is fond of energetic and playful dogs, the system applies a generative module, such as a stable diffusion model, to generate a virtual pet with similar characteristics.

In some cases, generating the virtual pet comprises applying the pet characteristic to a generative AI model as a prompt to receive an image of a pet. The generative AI module can be trained to generate images based on corresponding inputted prompts. The process begins by applying characteristics of the virtual pet (e.g., breed, color, size, features) as prompts to the generative AI model. These prompts serve as input instructions that guide the model in generating an image of the virtual pet.

The generative AI model can include a type of machine learning model trained to generate images based on specific input prompts. The model utilizes techniques such as deep learning and neural networks to learn patterns and features from training data.

In some cases, the generative AI model, which can include the stable diffusion model, is trained using a dataset of pet images. This dataset provides the model with a diverse range of pet characteristics, appearances, and variations to learn from. The stable diffusion model introduces noise iteratively to update pixel values in a generated image based on neighboring pixels. This iterative process refines the image generation by gradually adjusting pixel values to create realistic and detailed images.

During the image generation process, the stable diffusion model introduces noise, which represents small random variations in pixel values. This noise helps the model explore different possibilities and create diverse variations of the virtual pet image. The model iteratively updates pixel values based on neighboring pixels and the introduced noise. This iterative refinement process contributes to generating high-quality and visually appealing images of the virtual pet.

As the stable diffusion model iteratively refines pixel values based on the input prompts and noise, the model generates an image of the virtual pet. The output image reflects the characteristics and features specified in the prompts, such as the pet's breed, color patterns, facial expressions, and other details.

Identifying the prompt for the first user includes receiving a question or request from the first user via text or speech. The interaction system identifies keywords from the prompt and applies weights to each of the identified keywords. The interaction system applies the identified keywords and corresponding weights to the second machine learning model.

In some examples, the interaction system generates the prompt for the first user automatically based on an intent identified from real-time interaction data captured by the first interaction client. The interaction system generates prompts for a user based on a user's past activity, interests, and behavior patterns. The interaction system generates personalized prompts related to topics the user may find appealing, such as if a user frequently interacts with a certain type of content about technology.

In some examples, the interaction system uses popular or trending topics from the platform or the wider Internet to create prompts that are likely to be of interest to a broad audience. In some examples, by utilizing a user's geographic location, the interaction system can generate prompts that are relevant to their local area, such as events, news, or cultural topics. In some examples, the interaction system can create prompts based on the time of day, season, or upcoming events or holidays, such as events that are time sensitive. In some examples, the interaction system can use the user's social connections to generate prompts related to their friends, family, or other users they follow, such as a birthday or new connection with another user. In some examples, based on the user's activity within a specific application or AR experience, the interaction system can generate prompts related to that context.

In some examples, the interaction system can use the user's in-application actions, such as likes, comments, and shares, to generate prompts related to their interests. For example, if a user frequently interacts with content about cooking in a recipe application, the interaction system may generate a prompt for the user's favorite dish to prepare at home. In some examples, by utilizing sensors and data from the user's mobile device or AR headset, the interaction system creates context-aware prompts based on their physical environment. In some examples, the interaction system can generate prompts based on real-time events occurring within the application or AR experience, such as a live-streamed event. In some examples, the real-time interaction data includes a current camera feed from a camera system of the first interaction client.

In some examples, the interaction system uses the user's past activity, preferences, and behavior patterns within the application or AR experience to generate a prompt for the user. In some examples, the interaction system gathers user profile information, such as a calendar of appointments or objects detected in a camera feed of an AR device to generate a prompt. In some examples, by incorporating gamification elements, the interaction system creates prompts that encourage user participation and engagement, such as checking on a feature within a game.

In some examples, the interaction system selects from preconfigured pet avatars. The interaction system allows users to select from a range of preconfigured pet avatars. These preconfigured avatars are designed with specific characteristics and attributes, such as appearance, personality traits, and predefined behaviors. The preconfigured avatars ensure a diverse and appealing selection, catering to various user preferences and enhancing the user experience. By providing a curated set of pet avatars, the system simplifies the selection process, enabling users to quickly choose a pet that aligns with their desired aesthetic and interactive qualities.

These preconfigured pet avatars can include a variety of animal types, such as dogs, cats, cows, pandas, and more exotic animals, each with unique visual and behavioral traits. For instance, a preconfigured dog avatar might come with options for different breeds, colors, and accessories, while also exhibiting behaviors typical of its breed, such as playful energy or loyalty. This approach not only streamlines the customization process but also ensures that the pet avatars are well-designed and functionally consistent, providing users with an engaging and enjoyable experience as they interact with their virtual pets within the application.

The system either receives or requests geographic location information from the user. For example, the user can manually enter a specific location into the application. In some cases, the system uses the GPS functionality of the user's device to automatically determine their current location. In some cases, the user selects a location from a list of addresses or points of interest provided by the application. In some cases, the user selects a particular landmark, such as entering in a mountain name or the name of a restaurant.

FIG. 7 illustrates an example of setting a location for a pet avatar, according to some examples. In an example, the first user, Alice, opens the application and wants to set a map location for her pet avatar. The system uses the GPS functionality of Alice's smartphone to determine her current location and retrieves the geographic coordinates (e.g., latitude 37.7749, longitude −122.4194 for San Francisco). The system displays Alice's current geographic location on a map 702 with Alice's avatar 704 and Alice's pet avatar 706.

FIG. 8 illustrates a street view of the location set for the pet avatar, according to some examples. This figure showcases a user interface that integrates a real-world street view 802 with the user's avatar 804 and pet avatar 806 positioned in the scene. The interface provides a dynamic and immersive experience by merging virtual elements with real-world environments, allowing users to visualize their avatars and pets in actual locations.

The main background of the interface displays a realistic image or live feed of a street, captured using map data or AR technology. This could be sourced from third party services that provide such street views. The street view includes details such as buildings, sidewalks, trees, and other elements present in the real-world location, providing context and realism to the scene.

The user's avatar is positioned centrally in the street view. The user's avatar represents the user and is rendered in a way that matches the style and perspective of the real-world background. Accompanying the user's avatar, the pet avatar is also displayed in the street view. The pet avatar might be walking, sitting, or engaging in some activity, interacting naturally with the environment and the user's avatar.

Users might have controls to navigate or pan through the street view, allowing them to explore different parts of the real-world location. Options to customize the appearance and actions of the user and pet avatars are available, thereby enabling users to adjust their look and behavior to better fit the scene.

At operation 406, the interaction system accesses a particular geographic location for a first user. The system identifies and obtains information about a specific geographic location that is relevant to a first user. As described herein, the user can provide a certain address or name of a landmark to specify a geographical region. The user can move the map to a certain geographic location. The user can select to go to a location visited in the past, the current location of the first user, or the user's home.

At operation 408, the interaction system accesses map data for the particular geographic location. The system accesses the geographic location data, which includes latitude and longitude coordinates pinpointing the exact location. In some cases, the system accesses information about the region such as city, state, or country. The system can verify the accuracy and validity of the geographic location data, which may involve cross-referencing with mapping services or databases to ensure the location is correctly identified and can be used in subsequent steps.

Once the geographic location is identified, the system proceeds to retrieve the corresponding map data. The system sends a request to map service providers (such as Google Maps, OpenStreetMap, or other mapping APIs) for map data of the specified location. The retrieved map data can include various types of information, such as street maps with visual representations of streets, roads, and pathways; satellite imagery with high-resolution images of the Earth's surface, providing detailed views of buildings, landscapes, and other features; terrain data with information about the physical landscape, including elevations and natural features; and Point of Interest (POI) data with information about notable locations, such as restaurants, parks, and landmarks.

At operation 410, the interaction system identifies that the pet avatar is associated with the particular geographic location. This identification can be based on various criteria related to the second user's location or activities.

The system identifies the second user's pet avatar based on their current geographic location and displays pet avatars within a specific radius around that location. For example, if the second user is currently at a park, the system can show pet avatars of other users within a 500-meter radius of a particular location within the park or within the boundaries of the park. Identifying that the pet avatar for the second user is associated with the particular geographical location includes identifying all pet avatars within a specific radius around the geographic location, including the second user's pet avatar.

In some cases, the specific area to identify all pet avatars is within a certain geographic region, such as city limits-identifying all pet avatars within the boundaries of a specific city, such as all pet avatars located within the city limits of New York City, neighborhoods identifying all pet avatars within the confines of a particular neighborhood, such as the Chinatown neighborhood in San Francisco, districts identifying all pet avatars within a defined district, such as the Financial District in London, or postal codes identifying all pet avatars within a particular postal code, such as all pet avatars within the 90210 ZIP code area in Beverly Hills.

In some cases, the specific area to identify all pet avatars is within administrative boundaries identifying all pet avatars within administrative regions, such as the Greater London area or Los Angeles County, landmarks and surroundings identifying all pet avatars within a certain radius around a landmark, such as within 1 kilometer of the Eiffel Tower in Paris, parks and recreational areas identifying all pet avatars within the confines of a park, such as Central Park in New York City, campuses identifying all pet avatars within a university campus, such as the Stanford University campus, shopping malls identifying all pet avatars within a shopping mall, such as the Mall of America, or event venues identifying all pet avatars within the area of an event venue, such as the perimeter of the Staples Center in Los Angeles during a concert.

In some cases, the system uses the second user's registered home address to identify and display their pet avatar when the first user is viewing a map centered around that area. The second user's home is in a specific neighborhood, so when the first user views that neighborhood on the map, the second user's pet avatar appears at their home location.

In some cases, the system identifies locations that the second user has previously posted or shared in the application, such as check-ins or location tags, to identify their pet avatar. For example, the second user recently posted about being at a coffee shop downtown. When the first user views the map of downtown, the second user's pet avatar is shown at that coffee shop.

In some cases, the system tracks locations that the second user has visited frequently or historically and uses this data to identify where to display their pet avatar. For example, the second user often visits a particular beach. When the first user looks at the map of that beach area, the second user's pet avatar appears there.

In some cases, the system identifies the second user's pet avatar based on their current activity, such as attending an event or being at a specific venue. For example, the second user is currently at a music festival. The system shows their pet avatar at the festival location on the map.

In some cases, the system uses locations of scheduled events from the second user's calendar to identify where their pet avatar should appear. For example, the second user has a gym session scheduled. The system displays their pet avatar at the gym during the scheduled time. The system can access the user's schedule, identify a location disclosed within the scheduled event, and place the pet within the location of the scheduled event.

In some cases, the system identifies the second user's pet avatar at locations they frequently visit, such as favorite restaurants or parks. For example, the second user often goes to a specific dog park. The system shows their pet avatar at the dog park whenever the first user views that area.

In some cases, the system identifies the second user's pet avatar at their workplace if it is a significant and consistent location for them. For example, the second user works at a tech company headquarters. When the first user views the map around that headquarters, the second user's pet avatar is displayed.

In some cases, the system identifies the second user's pet avatar based on recent check-ins at events or locations. For example, the second user checked in at a sports stadium. The system shows their pet avatar at the stadium when the first user looks at that area.

In some cases, the system uses geotagged locations from the second user's social media posts to identify where their pet avatar should be displayed. For example, the second user posted a photo tagged at a famous landmark. The system shows their pet avatar at that landmark on the map.

In some cases, the system identifies the second user's pet avatar at locations they have traveled to recently or frequently. For example, the second user recently traveled to Paris. The system shows their pet avatar near the Eiffel Tower when the first user views the Paris map.

At operation 412, the interaction system causes display, on a first computing device of the first user, of the particular geographic location 420, the pet avatar 422, an interface element 424 configured to feed the pet avatar.

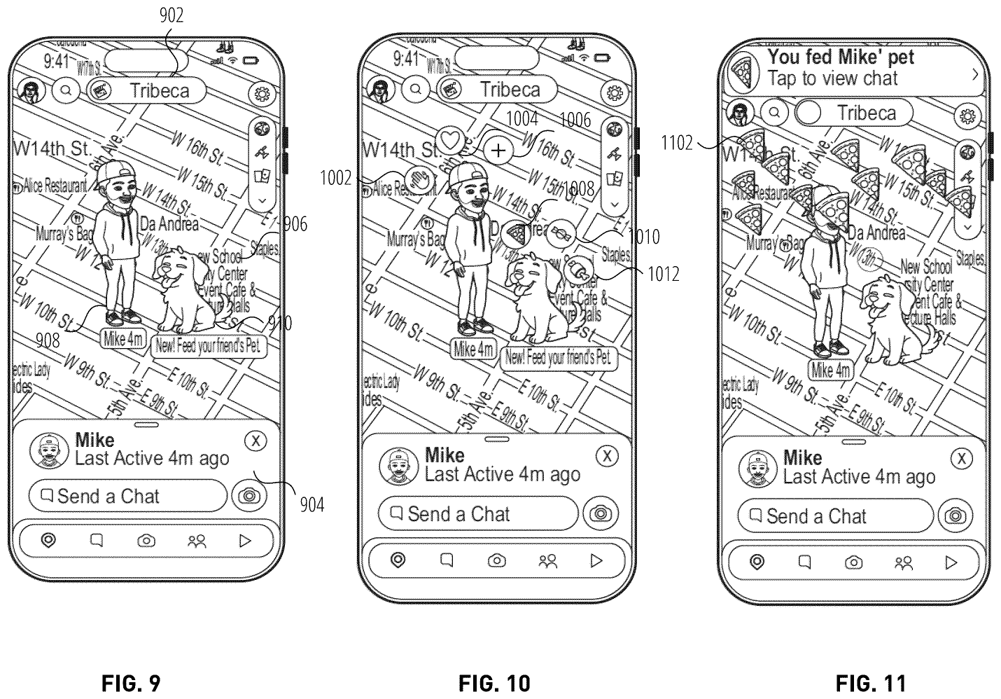

FIG. 9 illustrates a display for a first user of a particular geographic location with a user's pet avatar, according to some examples. A first user can interact with the interaction system to explore various geographic locations. For instance, if the first user is interested in checking out the Tribeca area in New York City, they can use the interaction system's search functionality 902 to locate and select Tribeca on the map. Upon this selection, the interaction system accesses the map data for the Tribeca area, which includes relevant details and coordinates for that geographic location.

Once the Tribeca area is selected, the system identifies all relevant pet avatars associated with that location. In this example, the system detects that Mike 904, a second user, has his pet avatar located within Tribeca. This identification process involves accessing the location data for various users and their associated pets, comparing it with the geographic boundaries of Tribeca, and determining that Mike's pet falls within this region.

Following this identification, the interaction system proceeds to display a map 906 of Tribeca on the first user's user interface. The map serves as a visual representation of the selected geographic location, providing context and spatial orientation. Along with the map, the interaction system displays the first user's avatar 908, representing their presence in the app. Additionally, the system displays an avatar for Mike's pet 910, visually indicating its presence within Tribeca.

FIG. 10 illustrates multiple user interface options for the first user to interact with the second user's pet, according to some examples. To enhance the interactive experience, the interaction system includes interface elements configured for user interaction with the pet avatar. The user interface is designed to offer a rich, interactive experience by providing various icons above both the user's avatar and the pet's avatar. These icons represent different actions the first user can take to enhance engagement and interaction within the app.

Above the first user's avatar, several icons can appear, each corresponding to a different action. There could be a hand icon 1002 that signifies a wave action. When the first user selects the hand icon, it triggers a waving animation on their avatar, signaling a friendly greeting to others, a message indicating that the user has said hi to that user, or create a post on social media feeds of the first, second, or other users of that interaction.

The interaction element could include a heart icon 1004 to like the user's avatar. When the first user clicks on the heart icon, the interaction system sends a notification to the other user indicating that their avatar has been liked. This can serve as a way to express admiration or positive acknowledgment.

The interaction element could include a plus icon 1006. The plus icon can represent a variety of additional actions. In some cases, the plus icon could be a friend request sending a friend request to the user, an invite to chat inviting the user to start a direct conversation, sending a gift by offering a virtual gift, such as a digital flower or a small token, or adding to a group by inviting the user to join a group chat or community. In some cases, the plus icon could initiate viewing of a profile to access more detailed information about the user, sharing of a location by sharing the first user's current location with the other user, sending a compliment by sending a pre-set or custom compliment message, or starting a game by inviting the user to play a built-in game within the app.

In some cases, the interaction system displays a user selectable element of a food (e.g., a chocolate) above a virtual pet avatar, accompanied by a visual cue denoting its potential harm or incompatibility with the pet's diet. When the user interacts with this interface, the system triggers an indicator warning against feeding the chocolate to the virtual pet.

Should the user proceed despite the warning and attempt to feed the chocolate to the pet, the interaction system responds dynamically. The interaction system can transform the virtual pet avatar into a visibly sick state, effectively conveying the consequences of the action, or initiates an animation illustrating the virtual pet experiencing nausea or vomiting, emphasizing the adverse effects of the ingested food.

Similarly, above the pet's avatar, icons are presented to allow the first user to interact with the pet in fun and meaningful ways. The icons (e.g., selectable user interface elements) can include a pizza icon 1008 that simulates feeding the pet a pizza slice, which could trigger an animation where the pet avatar happily eats the pizza; a candy icon 1010, which when selected could trigger the pet avatar to perform an excited animation indicating its enjoyment of the candy; or a meat icon 1012 for feeding the pet a piece of meat. This could result in the pet avatar displaying an animation of eating and showing contentment.

In some cases, the icon could include a toy icon representing playing with the pet, where the toy icon could show the pet avatar engaging in playful activities. In some cases, the icon could include a water icon giving the pet water to drink, showing a hydration animation. In some cases, the icon could include ball icon that initiates a game of fetch, where the pet avatar plays with a ball.

These icons not only provide a diverse range of interactions but also enrich the user experience by enabling personalized and engaging actions. The interface is designed to be intuitive and visually appealing, making it easy for users to interact with each other and their virtual pets in enjoyable and meaningful ways. The overall design aims to create a lively and dynamic environment, fostering connections and fun within the interaction system.

Returning to FIG. 4, at operation 414, the interaction system receives a user selection of the interface element from the first user. For example, the user can select to feed the pet avatar a pizza out of the pizza icon, candy icon, and meat icon.

At operation 416, the interaction system causes display, on the first computing device for the first user, an indication of the pet avatar being fed corresponding to the interface element. There are numerous engaging ways to visually display that the pet is being fed on the first user's computing device.

In some cases, the interaction system displays direct animation where the pet avatar performs an eating animation where it visually consumes the food item selected by the user (e.g., the pet avatar bites and chews a pizza slice).

In some cases, the interaction system displays visual effects. For example, the interaction system can display falling food items as a cascade of the selected food items (e.g., multiple pizzas) falls from the top of the screen, surrounding the pet avatar before it starts eating. The interaction system can display food glow and sparkle where the selected food item glows and sparkles as it moves towards the pet avatar, indicating a special treat is being given. The interaction system can display food transformation where the food item morphs into an energy burst or a visual effect (like a glowing aura) that envelops the pet, symbolizing nourishment.

FIG. 11 illustrates a user interface displaying visual effects of falling food items to indicate feeding of the pet, according to some examples. If the user selects a pizza to feed the pet, the interaction system can display a plurality of pizzas 1102 falling from the top of the screen to the bottom of the screen confirming the user selection.

In some cases, the interaction system can display background changes. The interaction system can display themed backgrounds where the background temporarily changes to a themed setting that matches the food item (e.g., an Italian restaurant background appears when feeding the pet pizza). The interaction system can display a feeding zone highlight where the area around the pet avatar lights up or gets highlighted, focusing attention on the feeding action.

In some cases, the interaction system can display interactive elements such as user interaction where the first user can drag and drop the food item onto the pet avatar, which then triggers the eating animation.

In some cases, the interaction system can display pet reactions. The interaction system can display expressive pet animations where the pet avatar shows visible reactions such as licking its lips, wagging its tail, or performing a happy dance after eating. The interaction system can display pet voice effects where the pet makes satisfied noises or playful sounds while eating, adding an auditory confirmation to the visual display.

In some cases, the interaction system can display AR elements. The interaction system can display an AR overlay, such as if using AR, the pet avatar and food items appear in the user's real-world environment, where the user can interact with the pet using their device's camera.

In some cases, the interaction system can display visual feedback. The interaction system can display a fullness meter where a meter or bar appears showing the pet's fullness level increasing as it eats the food. The interaction system can display floating icons where small floating icons (e.g., hearts or stars) appear around the pet avatar, indicating happiness or satisfaction.

In some cases, the interaction system can display creative enhancements. The interaction system can display a fireworks display where a mini fireworks display or confetti explosion occurs around the pet avatar to celebrate feeding time. The interaction system can display a magic transformation where the pet avatar briefly transforms into a supercharged version of itself (e.g., glowing or larger in size) after being fed. The interaction system can display a food parade where a parade of the selected food items marches across the screen towards the pet avatar, which then eagerly consumes them. The interaction system can display a mini game where the feeding action initiates a quick mini-game where the first user helps the pet catch falling food items to eat.

In some cases, the interaction system can display social elements. The interaction system can display shared feasting where if multiple users' pets are nearby, a communal feast animation appears where all the pets gather and eat together. The interaction system can display pet commentary where the pet avatar might “speak” (via text bubbles or voice) to thank the user or make a humorous comment about the food. The interaction system can display user-generated content allowing users to customize the feeding animation with their own effects or themes, making the experience more personalized.

By incorporating these diverse visual and interactive methods, the app can create a rich and engaging experience that makes the action of feeding the pet avatar enjoyable and memorable for the users. Each method adds a unique touch, enhancing the overall interactivity and satisfaction within the app.

At operation 418, the interaction system transmits a notification to a second computing device of the second user including an indication that the pet avatar is being fed corresponding to the interface element.

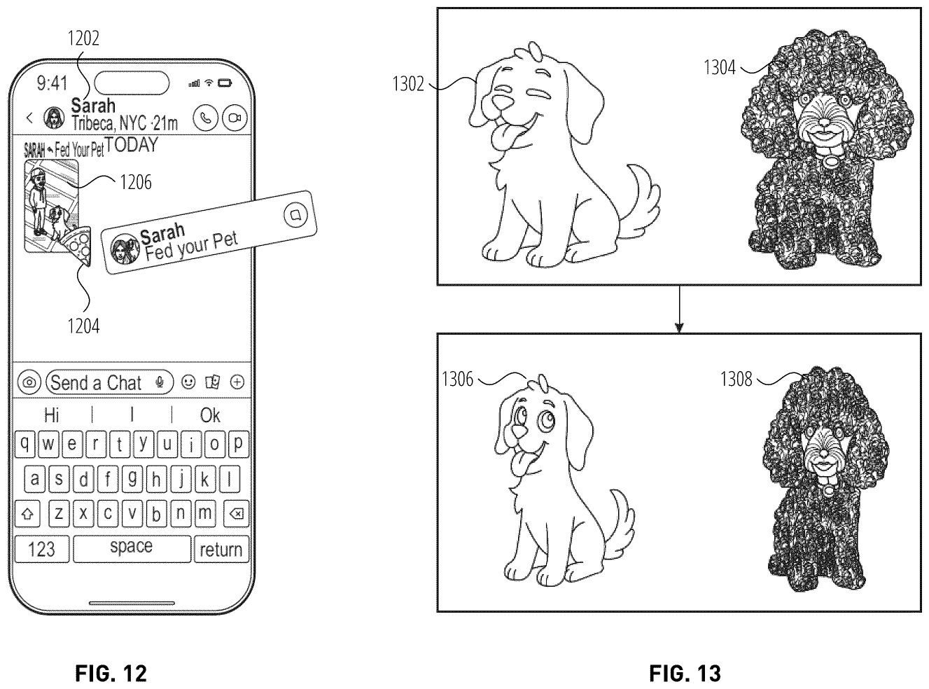

FIG. 12 illustrates an example of a notification that is transmitted to the second user indicating that the second user's pet is being fed by the first user, according to some examples.

This notification includes the identity of the first user 1202, the type of food given 1204, and any relevant context, such as the time and location 1206 of the interaction. By assembling this information, the system ensures that the second user receives a comprehensive update on their pet's status.

Upon the preparation of the notification, the interaction system uses its communication protocols to transmit the message to the second computing device. This transmission can occur through various channels, such as push notifications, in-app messages, or even email, depending on the app's configuration and the user's preferences. The system prioritizes real-time delivery to maintain the immediacy of the interaction. The notification might be accompanied by visual and auditory cues, such as a sound alert or a popup banner, to capture the second user's attention effectively. This immediate feedback mechanism is designed to keep the second user engaged and aware of their pet's interactions with others in real-time.

Upon receiving the notification, the second user's device displays the message, informing them that their pet avatar has been fed by the first user. This display might include a brief animation or a visual update on the pet avatar itself, such as a happy expression or a fullness meter increase, thereby reinforcing the interaction's context. The second user can then acknowledge the notification and possibly respond, either by thanking the first user, returning the favor, or engaging in further interaction within the app. This step completes the interaction loop, fostering a sense of community and ongoing engagement among users. By ensuring timely and informative notifications, the interaction system enhances the overall user experience and maintains a lively, interactive environment within the app.

Feeding the pet in this application can go beyond simple animations and introduce dynamic transformations that reflect the type and quantity of food given. These transformations can be driven by generative AI, allowing the pet avatar to change its appearance or attributes in response to specific feeding patterns.

Different food items can be associated with specific transformation triggers. For example, feeding the pet a lot of meat could trigger muscle-building transformations, consuming large quantities of burgers or junk food could cause the pet to become chubbier or gain weight, or feeding the pet salads, fruits, or other healthy foods might lead to a leaner, more energetic appearance.

When the first user selects a food item to feed the pet, the interaction system logs this action and tracks the type and quantity of food given. Over time, this data accumulates to provide a basis for transformation triggers.

The system employs a generative AI model trained on various pet characteristics and transformations. This model can take input data (the type and quantity of food) and generate new versions of the pet avatar that reflect these changes. The AI model uses techniques such as stable diffusion to create realistic and seamless transformations.

As the pet is fed, the system maintains a log of the feeding history. For example, if the pet is fed meat consistently, the system recognizes this pattern and prepares to initiate the muscle-building transformation. Once the feeding pattern meets certain criteria (e.g., a threshold amount of meat), the generative AI model processes the input. It uses the current pet avatar as a base and applies the transformation rules to create a new version of the pet. This new version might have more defined muscles, a bulkier frame, or other attributes associated with strength.

The transformed pet avatar is then updated in the system. Visual changes might include increased muscle mass, a more robust physique, or even altered posture to reflect the new strength. Behavioral changes could also be integrated, such as the pet performing strength-related actions (e.g., flexing muscles or lifting objects).

The new pet avatar is displayed to the first user in real-time. The system ensures a smooth transition by using animations or gradual morphing effects, so the transformation feels natural and engaging.

To reinforce the transformation, the system might display messages or notifications such as “Your pet is getting stronger!” or “Your pet has gained muscle from eating meat.” This feedback keeps the user informed and engaged.

In some cases, the transformation is not a one-time event. The pet avatar can continue to evolve based on ongoing interactions and feeding patterns. If the user switches to feeding the pet healthy foods after a period of muscle-building, the pet might gradually shift to a leaner appearance, reflecting a balanced diet.

Users can have the option to customize how their pet transforms by selecting specific goals or traits they want their pet to develop. The generative AI can tailor the transformations to match these preferences, providing a personalized experience.

Users can share their pet's transformations with friends or within the app's community, showcasing their pet's unique evolution. This can encourage social interaction and engagement as users compare their pets and discuss different feeding strategies.

By integrating generative AI, the interaction system creates a dynamic and immersive experience where the pet avatar continuously evolves based on user interactions. This not only enhances the visual appeal of the pet but also deepens the emotional connection between the user and their virtual companion, making the app more engaging and enjoyable.

The pet avatars can be in the form of a media content item. The media content items include:
Content augmentations to enhance images, videos, or other media content items to share with others, such as by adjusting the color or appearance or adding interactive elements such as animations and facial transformations, in real-time.
Emojis are small images or icons that represent emotions, reactions, or objects.
Stickers are larger images or animations that can be sent in a chat window.
Images or photographs can be sent to other users to share visual information or document a particular event.
Video clips can be used to share recorded content or document a particular event.
Audio messages can be shared to communicate audible communication.
Graphics Interchange Formats (GIFs) are short animations that can be used to add humor or express emotions.

Systems and methods described herein include training a machine learning network, such as training to generate pet avatars or transform avatars. The machine learning network can be trained to receive characteristics of pet avatars, as further described herein, and automatically generate custom pet avatars that have never been seen or created before. The machine learning algorithm can be trained using historical information that include historical pet characteristics, and resulting pet avatars.

Training of models, such as artificial intelligence models, is necessarily rooted in computer technology, and improves modeling technology by using training data to train such models and thereafter apply the models to new inputs to make inferences on the new inputs. Here, the new inputs can be brand new pet characteristics. The trained machine learning model can generate brand new pet avatars from the combination of pet characteristics.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models. Such training is the framework of machine learning algorithms that enable the models to be applied to new and unseen data (such as new pet characteristics data) and make predictions that the model was trained for based on the weights or scores that were adjusted during training. Such training of the machine learning models described herein reduces false positives and increases the performance.

### Stretch and Squash

FIG. 13 illustrates an example of stretching and squashing an image to indicate an action of the pet avatar, according to some examples. Animating the pet feeding process can be made efficient and visually engaging by using techniques that manipulate the existing pet avatar image rather than rendering entirely new animations or images.

In some cases, the interaction system deforms an existing image of the pet avatar to create a sense of movement and action. For example, a first pet avatar 1302 and a second pet avatar 1304 are the original images of the pet avatars. When the pet eats, the display can stretch and squash the pet to show that the pet avatar is eating. The squashed first pet avatar 1306 and the squashed second pet avatar 1308 are shown to be horizontally squashed. For example, the display can stretch the pet vertically slightly as it reaches for the food, indicating an upward motion, and squash the pet horizontally when it bites into the food, suggesting compression and engagement with the food item.

In some cases, small, incremental changes to the pet avatar's existing image can simulate movement. The interaction system can create jaw movement by slightly adjusting the pet's jaw area to open and close to mimic chewing. The interaction system can create eye movement by moving the pet's eyes or adding blinking animations to make the pet appear more lifelike and reactive.

The interaction system can use overlays, and additional layers on the existing pet avatar image can simulate different actions. The interaction system can display food overlays by adding a food image layer that moves towards the pet's mouth and then fades out as if the pet ate it. The interaction system can display a glow or aura by applying a glowing aura around the pet when it eats to indicate happiness or satisfaction.

The interaction system can display transformations such as rotation. A slight rotation of the pet avatar to one side and back can imply a head tilt or curious look. The interaction system can display scaling by gradually scaling the pet image up and down to simulate breathing or excitement.

### Data Communications Architecture

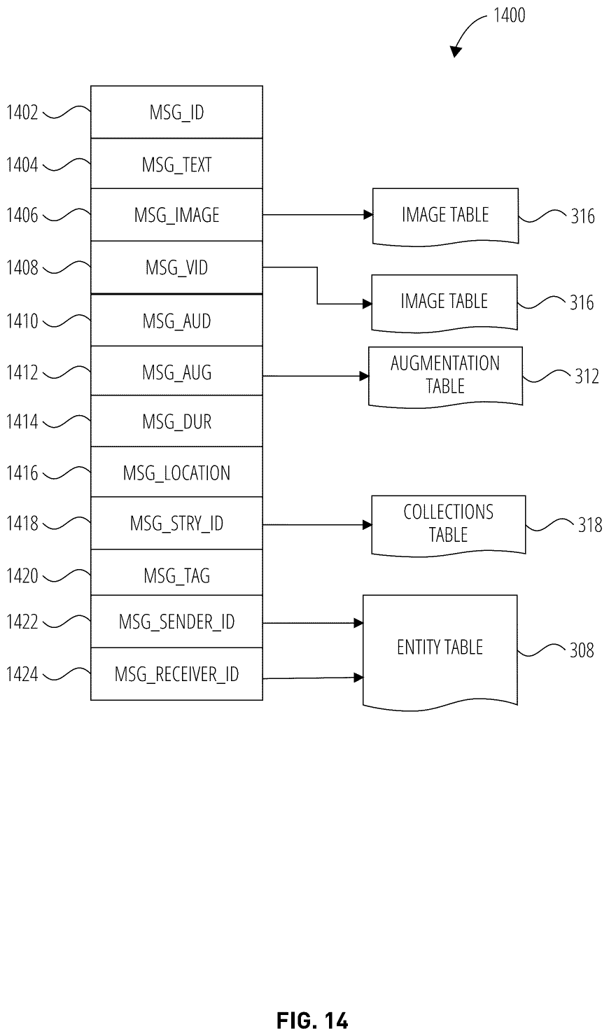

FIG. 14 is a schematic diagram illustrating a structure of a message 1400, according to some examples, generated by an interaction client 104 for communication to a further interaction client 104 via the interaction servers 124. The content of a particular message 1400 is used to populate the message table 306 stored within the database 304, accessible by the interaction servers 124. Similarly, the content of a message 1400 is stored in memory as “in-transit” or “in-flight” data of the user system 102 or the interaction servers 124. A message 1400 is shown to include the following example components:
Message identifier 1402: a unique identifier that identifies the message 1400.
Message text payload 1404: text, to be generated by a user via a user interface of the user system 102, and that is included in the message 1400.
Message image payload 1406: image data, captured by a camera component of a user system 102 or retrieved from a memory component of a user system 102, and that is included in the message 1400. Image data for a sent or received message 1400 may be stored in the image table 316.
Message video payload 1408: video data, captured by a camera component or retrieved from a memory component of the user system 102, and that is included in the message 1400. Video data for a sent or received message 1400 may be stored in the image table 316.
Message audio payload 1410: audio data, captured by a microphone or retrieved from a memory component of the user system 102, and that is included in the message 1400.
Message augmentation data 1412: augmentation data (e.g., filters, stickers, or other annotations or enhancements) that represents augmentations to be applied to message image payload 1406, message video payload 1408, or message audio payload 1410 of the message 1400. Augmentation data for a sent or received message 1400 may be stored in the augmentation table 312.
Message duration parameter 1414: parameter value indicating, in seconds, the amount of time for which content of the message (e.g., the message image payload 1406, message video payload 1408, message audio payload 1410) is to be presented or made accessible to a user via the interaction client 104.
Message geolocation parameter 1416: geolocation data (e.g., latitudinal and longitudinal coordinates) associated with the content payload of the message. Multiple message geolocation parameter 1416 values may be included in the payload, each of these parameter values being associated with respect to content items included in the content (e.g., a specific image within the message image payload 1406, or a specific video in the message video payload 1408).
Message story identifier 1418: identifier values identifying one or more content collections (e.g., “stories” identified in the collections table 318) with which a particular content item in the message image payload 1406 of the message 1400 is associated. For example, multiple images within the message image payload 1406 may each be associated with multiple content collections using identifier values.
Message tag 1420: each message 1400 may be tagged with multiple tags, each of which is indicative of the subject matter of content included in the message payload. For example, where a particular image included in the message image payload 1406 depicts an animal (e.g., a lion), a tag value may be included within the message tag 1420 that is indicative of the relevant animal. Tag values may be generated manually, based on user input, or may be automatically generated using, for example, image recognition.
Message sender identifier 1422: an identifier (e.g., a messaging system identifier, email address, or device identifier) indicative of a user of the user system 102 on which the message 1400 was generated and from which the message 1400 was sent.
Message receiver identifier 1424: an identifier (e.g., a messaging system identifier, email address, or device identifier) indicative of a user of the user system 102 to which the message 1400 is addressed.

The contents (e.g., values) of the various components of message 1400 may be pointers to locations in tables within which content data values are stored. For example, an image value in the message image payload 1406 may be a pointer to (or address of) a location within an image table 316. Similarly, values within the message video payload 1408 may point to data stored within an image or video table 316, values stored within the message augmentation data 1412 may point to data stored in an augmentation table 312, values stored within the message story identifier 1418 may point to data stored in a collections table 318, and values stored within the message sender identifier 1422 and the message receiver identifier 1424 may point to user records stored within an entity table 308.

System with Head-Wearable Apparatus

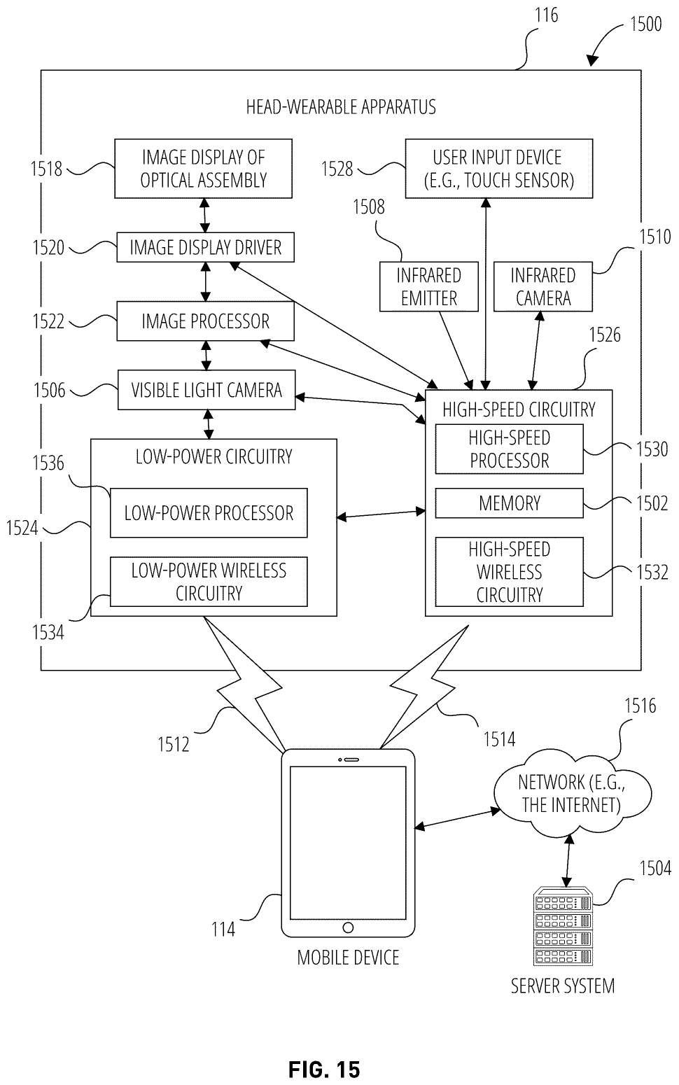

FIG. 15 illustrates a system 1500 including a head-wearable apparatus 116 with a selector input device, according to some examples. FIG. 15 is a high-level functional block diagram of an example head-wearable apparatus 116 communicatively coupled to a mobile device 114 and various server systems 1504 (e.g., the interaction server system 110) via various networks 108. The networks 108 may include any combination of wired and wireless connections.

The head-wearable apparatus 116 includes one or more cameras, each of which may be, for example, a visible light camera 1506, an infrared emitter 1508, and an infrared camera 1510.

An interaction client, such as a mobile device 114 connects with head-wearable apparatus 116 using both a low-power wireless connection 1512 and a high-speed wireless connection 1514. The mobile device 114 is also connected to the server system 1504 and the network 1516.

The head-wearable apparatus 116 further includes two image displays of the image display of optical assembly 1518. The two image displays of optical assembly 1518 include one associated with the left lateral side and one associated with the right lateral side of the head-wearable apparatus 116. The head-wearable apparatus 116 also includes an image display driver 1520, an image processor 1522, low-power circuitry 1524, and high-speed circuitry 1526. The image display of optical assembly 1518 is for presenting images and videos, including an image that can include a graphical user interface to a user of the head-wearable apparatus 116.

The image display driver 1520 commands and controls the image display of optical assembly 1518. The image display driver 1520 may deliver image data directly to the image display of optical assembly 1518 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1528 (e.g., touch sensor or push button), including an input surface on the head-wearable apparatus 116. The user input device 1528 (e.g., touch sensor or push button) is to receive from the user an input selection to manipulate the graphical user interface of the presented image.

The components shown in FIG. 15 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1506 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1502, which stores instructions to perform a subset or all of the functions described herein. The memory 1502 can also include storage device.

As shown in FIG. 15, the high-speed circuitry 1526 includes a high-speed processor 1530, a memory 1502, and high-speed wireless circuitry 1532. In some examples, the image display driver 1520 is coupled to the high-speed circuitry 1526 and operated by the high-speed processor 1530 in order to drive the left and right image displays of the image display of optical assembly 1518. The high-speed processor 1530 may be any processor capable of managing high-speed communications and operation of any general computing system needed for the head-wearable apparatus 116. The high-speed processor 1530 includes processing resources needed for managing high-speed data transfers on a high-speed wireless connection 1514 to a wireless local area network (WLAN) using the high-speed wireless circuitry 1532. In certain examples, the high-speed processor 1530 executes an operating system such as a LINUX operating system or other such operating system of the head-wearable apparatus 116, and the operating system is stored in the memory 1502 for execution. In addition to any other responsibilities, the high-speed processor 1530 executing a software architecture for the head-wearable apparatus 116 is used to manage data transfers with high-speed wireless circuitry 1532. In certain examples, the high-speed wireless circuitry 1532 is configured to implement Institute of Electrical and Electronic Engineers (IEEE) 802.11 communication standards, also referred to herein as WI-FI®. In some examples, other high-speed communications standards may be implemented by the high-speed wireless circuitry 1532.

The low-power wireless circuitry 1534 and the high-speed wireless circuitry 1532 of the head-wearable apparatus 116 can include short-range transceivers (Bluetooth™) and wireless wide, local, or wide area network transceivers (e.g., cellular or WI-FI®). Mobile device 114, including the transceivers communicating via the low-power wireless connection 1512 and the high-speed wireless connection 1514, may be implemented using details of the architecture of the head-wearable apparatus 116, as can other elements of the network 1516.

The memory 1502 includes any storage device capable of storing various data and applications, including, among other things, camera data generated by the left and right visible light cameras 1506, the infrared camera 1510, and the image processor 1522, as well as images generated for display by the image display driver 1520 on the image displays of the image display of optical assembly 1518. While the memory 1502 is shown as integrated with high-speed circuitry 1526, in some examples, the memory 1502 may be an independent standalone element of the head-wearable apparatus 116. In certain such examples, electrical routing lines may provide a connection through a chip that includes the high-speed processor 1530 from the image processor 1522 or the low-power processor 1536 to the memory 1502. In some examples, the high-speed processor 1530 may manage addressing of the memory 1502 such that the low-power processor 1536 will boot the high-speed processor 1530 any time that a read or write operation involving memory 1502 is needed.

As shown in FIG. 15, the low-power processor 1536 or high-speed processor 1530 of the head-wearable apparatus 116 can be coupled to the camera (visible light camera 1506, infrared emitter 1508, or infrared camera 1510), the image display driver 1520, the user input device 1528 (e.g., touch sensor or push button), and the memory 1502.

The head-wearable apparatus 116 is connected to a host computer. For example, the head-wearable apparatus 116 is paired with the mobile device 114 via the high-speed wireless connection 1514 or connected to the server system 1504 via the network 1516. The server system 1504 may be one or more computing devices as part of a service or network computing system, for example, that includes a processor, a memory, and network communication interface to communicate over the network 1516 with the mobile device 114 and the head-wearable apparatus 116.

The mobile device 114 includes a processor and a network communication interface coupled to the processor. The network communication interface allows for communication over the network 1516, low-power wireless connection 1512, or high-speed wireless connection 1514. Mobile device 114 can further store at least portions of the instructions in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1504, such as the user input device 1528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1512 and high-speed wireless connection 1514 from the mobile device 114 via the low-power wireless circuitry 1534 or high-speed wireless circuitry 1532.

### Machine Architecture

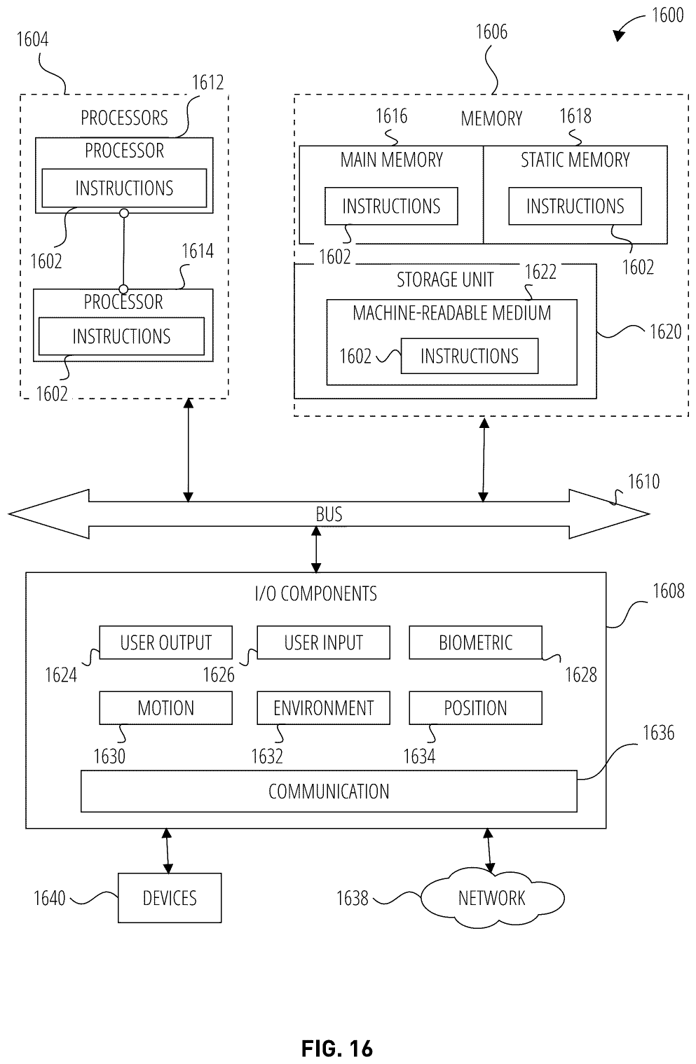

FIG. 16 is a diagrammatic representation of the machine 1600 within which instructions 1602 (e.g., software, a program, an application, an applet, an app, or other executable code) for causing the machine 1600 to perform any one or more of the methodologies discussed herein may be executed. For example, the instructions 1602 may cause the machine 1600 to execute any one or more of the methods described herein. The instructions 1602 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1602, sequentially or otherwise, that specify actions to be taken by the machine 1600. Further, while a single machine 1600 is illustrated, the term “machine” shall also be taken to include a collection of machines that individually or jointly execute the instructions 1602 to perform any one or more of the methodologies discussed herein. The machine 1600, for example, may comprise the user system 102 or any one of multiple server devices forming part of the interaction server system 110. In some examples, the machine 1600 may also comprise both client and server systems, with certain operations of a particular method or algorithm being performed on the server-side and with certain operations of the particular method or algorithm being performed on the client-side.

The machine 1600 may include processors 1604, memory 1606, and input/output I/O components 1608, which may be configured to communicate with each other via a bus 1610. In an example, the processors 1604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1612 and a processor 1614 that execute the instructions 1602. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single-core, a single processor with multiple cores (e.g., a multi-core processor), multiple processors with a single core, multiple processors with multiples cores, or any combination thereof.

The memory 1606 includes a main memory 1616, a static memory 1618, and a storage unit 1620, both accessible to the processors 1604 via the bus 1610. The main memory 1606, the static memory 1618, and storage unit 1620 store the instructions 1602 embodying any one or more of the methodologies or functions described herein. The instructions 1602 may also reside, completely or partially, within the main memory 1616, within the static memory 1618, within machine-readable medium 1622 within the storage unit 1620, within at least one of the processors 1604 (e.g., within the processor's cache memory), or any suitable combination thereof, during execution thereof by the machine 1600.

The I/O components 1608 may include a wide variety of components to receive input, provide output, produce output, transmit information, exchange information, capture measurements, and so on. The specific I/O components 1608 that are included in a particular machine will depend on the type of machine. For example, portable machines such as mobile phones may include a touch input device or other such input mechanisms, while a headless server machine will likely not include such a touch input device. It will be appreciated that the I/O components 1608 may include many other components that are not shown in FIG. 16. In various examples, the I/O components 1608 may include user output components 1624 and user input components 1626. The user output components 1624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1608 may include biometric components 1628, motion components 1630, environmental components 1632, or position components 1634, among a wide array of other components. For example, the biometric components 1628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like.

The motion components 1630 include acceleration sensor components (e.g., accelerometer), gravitation sensor components, rotation sensor components (e.g., gyroscope).

The environmental components 1632 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1608 further include communication components 1636 operable to couple the machine 1600 to a network 1638 or devices 1640 via respective coupling or connections. For example, the communication components 1636 may include a network interface component or another suitable device to interface with the network 1638. In further examples, the communication components 1636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1640 may be another machine or any of a wide variety of peripheral devices (e.g., a peripheral device coupled via a USB).

Moreover, the communication components 1636 may detect identifiers or include components operable to detect identifiers. For example, the communication components 1636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1636, such as location via Internet Protocol (IP) geolocation, location via Wi-Fi® signal triangulation, location via detecting an NFC beacon signal that may indicate a particular location, and so forth.

The various memories (e.g., main memory 1616, static memory 1618, and memory of the processors 1604) and storage unit 1620 may store one or more sets of instructions and data structures (e.g., software) embodying or used by any one or more of the methodologies or functions described herein. These instructions (e.g., the instructions 1602), when executed by processors 1604, cause various operations to implement the disclosed examples.

The instructions 1602 may be transmitted or received over the network 1638, using a transmission medium, via a network interface device (e.g., a network interface component included in the communication components 1636) and using any one of several well-known transfer protocols (e.g., hypertext transfer protocol (HTTP)). Similarly, the instructions 1602 may be transmitted or received using a transmission medium via a coupling (e.g., a peer-to-peer coupling) to the devices 1640.

### Software Architecture

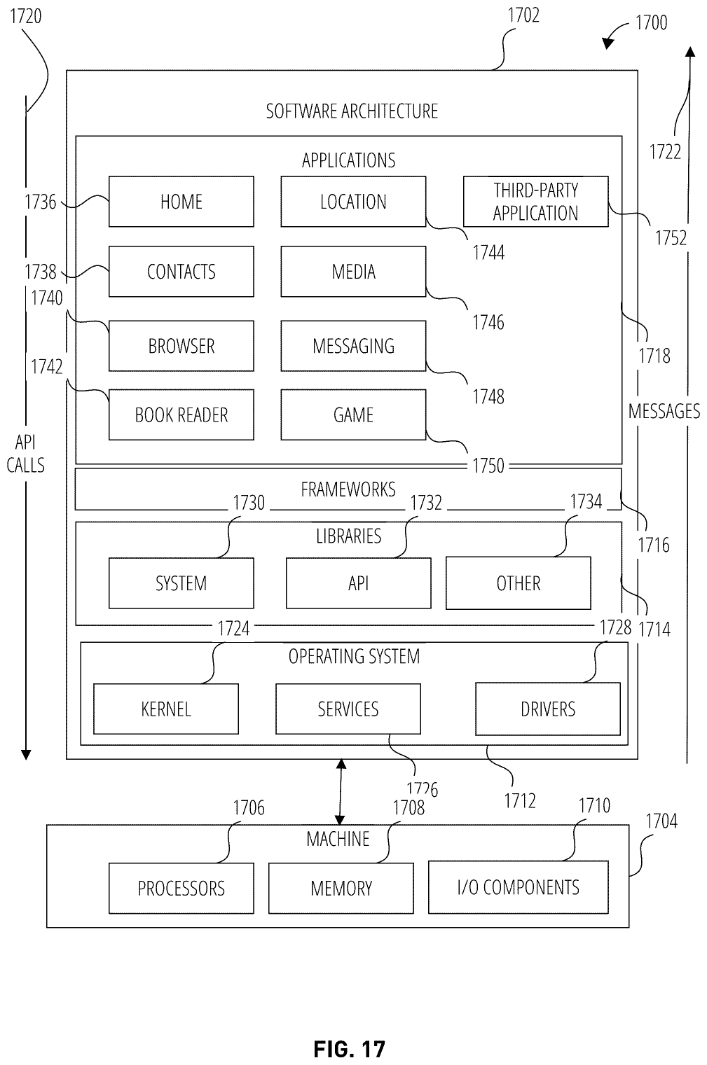

FIG. 17 is a block diagram 1700 illustrating a software architecture 1702, which can be installed on any one or more of the devices described herein. The software architecture 1702 is supported by hardware such as a machine 1704 that includes processors 1706, memory 1708, and I/O components 1710. In this example, the software architecture 1702 can be conceptualized as a stack of layers, where each layer provides a particular functionality. The software architecture 1702 includes layers such as an operating system 1712, libraries 1714, frameworks 1716, and applications 1718. Operationally, the applications 1718 invoke API calls 1720 through the software stack and receive messages 1722 in response to the API calls 1720.

The operating system 1712 manages hardware resources and provides common services. The operating system 1712 includes, for example, a kernel 1724, services 1726, and drivers 1728. The kernel 1724 acts as an abstraction layer between the hardware and the other software layers. For example, the kernel 1724 provides memory management, processor management (e.g., scheduling), component management, networking, and security settings, among other functionalities. The services 1726 can provide other common services for the other software layers. The drivers 1728 are responsible for controlling or interfacing with the underlying hardware. For instance, the drivers 1728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1714 provide a common low-level infrastructure used by the applications 1718. The libraries 1714 can include system libraries 1730 (e.g., C standard library) that provide functions such as memory allocation functions, string manipulation functions, mathematic functions, and the like. In addition, the libraries 1714 can include API libraries 1732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1714 can also include a wide variety of other libraries 1734 to provide many other APIs to the applications 1718.

The frameworks 1716 provide a common high-level infrastructure that is used by the applications 1718. For example, the frameworks 1716 provide various graphical user interface (GUI) functions, high-level resource management, and high-level location services. The frameworks 1716 can provide a broad spectrum of other APIs that can be used by the applications 1718, some of which may be specific to a particular operating system or platform.

In an example, the applications 1718 may include a home application 1736, a contacts application 1738, a browser application 1740, a book reader application 1742, a location application 1744, a media application 1746, a messaging application 1748, a game application 1750, and a broad assortment of other applications such as a third-party application 1752. The applications 1718 are programs that execute functions defined in the programs. Various programming languages can be employed to create one or more of the applications 1718, structured in a variety of manners, such as object-oriented programming languages (e.g., Objective-C, Java, or C++) or procedural programming languages (e.g., C or assembly language). In a specific example, the third-party application 1752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1752 can invoke the API calls 1720 provided by the operating system 1712 to facilitate functionalities described herein.

### Machine-Learning Pipeline

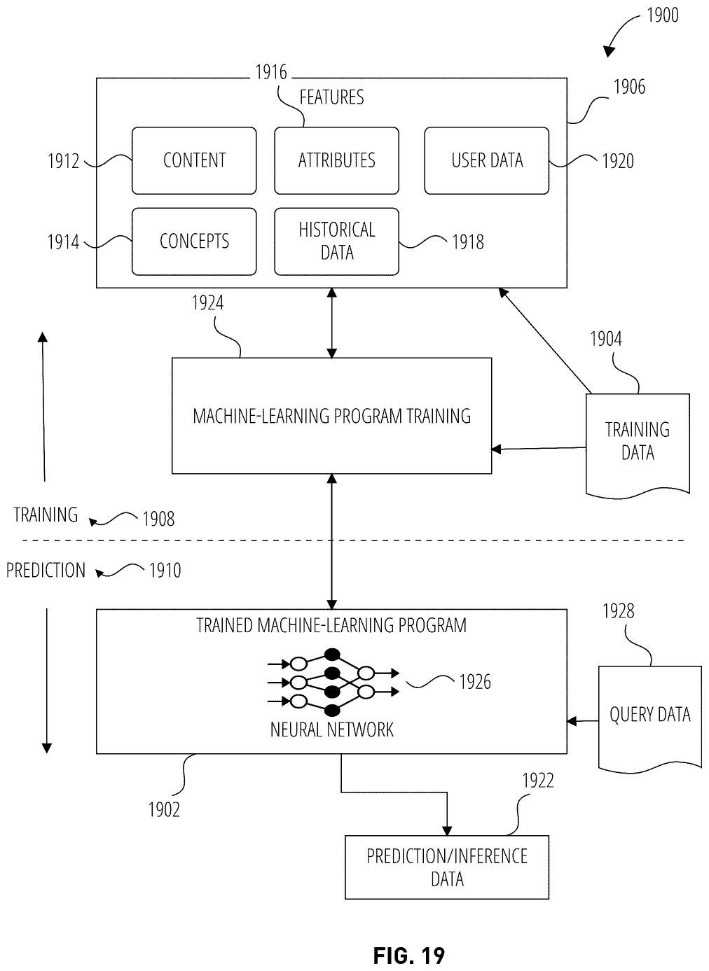

FIG. 19 is a flowchart depicting a machine-learning pipeline 1900, according to some examples. The machine-learning pipelines 1900 may be used to generate a trained model, for example the trained machine-learning program 1902 of FIG. 19, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

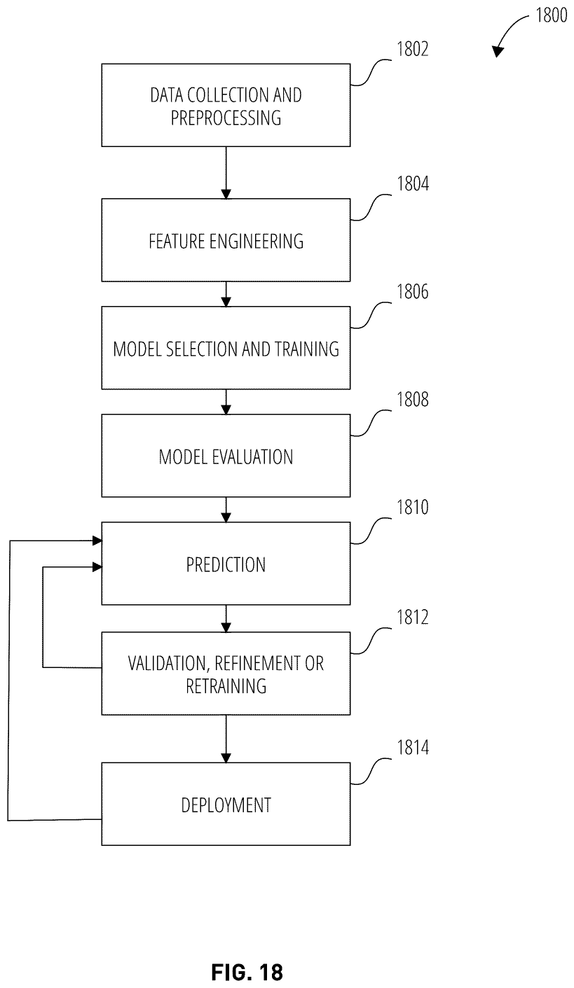

Generating a trained machine-learning program 1902 may include multiple types of phases that form part of the machine-learning pipeline 1900, including for example the following phases 1800 illustrated in FIG. 18:
Data collection and preprocessing 1802: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1804: This may include selecting and transforming the training data 1904 to create features that are useful for predicting the target variable. Feature engineering may include (1) receiving features 1906 (e.g., as structured or labeled data in supervised learning) and/or (2) identifying features 1906 (e.g., unstructured or unlabeled data for unsupervised learning) in training data 1904.
Model selection and training 1806: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1808: This may include evaluating the performance of a trained model (e.g., the trained machine-learning program 1902) on a separate testing dataset. This can help determine if the model is overfitting or underfitting and if it is suitable for deployment.
Prediction 1810: This involves using a trained model (e.g., trained machine-learning program 1902) to generate predictions on new, unseen data.
Validation, refinement or retraining 1812: This may include updating a model based on feedback generated from the prediction phase, such as new data or user feedback.
Deployment 1814: This may include integrating the trained model (e.g., the trained machine-learning program 1902) into a larger system or application, such as a web service, mobile app, or IoT device. This can involve setting up APIs, building a user interface, and ensuring that the model is scalable and can handle large volumes of data.

FIG. 19 illustrates two example phases, namely a training phase 1908 (part of the model selection and trainings 1806) and a prediction phase 1910 (part of prediction 1810). Prior to the training phase 1908, feature engineering 1804 is used to identify features 1906. This may include identifying informative, discriminating, and independent features for the effective operation of the trained machine-learning program 1902 in pattern recognition, classification, and regression. In some examples, the training data 1904 includes labeled data, which is known data for pre-identified features 1906 and one or more outcomes.

Each of the features 1906 may be a variable or attribute, such as individual measurable property of a process, article, system, or phenomenon represented by a data set (e.g., the training data 1904). Features 1906 may also be of different types, such as numeric features, strings, vectors, matrices, encodings, and graphs, and may include one or more of content 1912, concepts 1914, attributes 1916, historical data 1918 and/or user data 1920, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1908, the machine-learning pipeline 1900 uses the training data 1904 to find correlations among the features 1906 that affect a predicted outcome or prediction/inference data 1922.

With the training data 1904 and the identified features 1906, the trained machine-learning program 1902 is trained during the training phase 1908 during machine-learning program training 1924. The machine-learning program training 1924 appraises values of the features 1906 as they correlate to the training data 1904. The result of the training is the trained machine-learning program 1902 (e.g., a trained or learned model).

Further, the training phase 1908 may involve machine learning, in which the training data 1904 is structured (e.g., labeled during preprocessing operations), and the trained machine-learning program 1902 implements a relatively simple neural network 1926 capable of performing, for example, classification and clustering operations. In other examples, the training phase 1908 may involve deep learning, in which the training data 1904 is unstructured, and the trained machine-learning program 1902 implements a deep neural network 1926 that is able to perform both feature extraction and classification/clustering operations.

A neural network 1926 may, in some examples, be generated during the training phase 1908, and implemented within the trained machine-learning program 1902. The neural network 1926 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1926 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1926 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1908, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1926 is iteratively trained by adjusting model parameters to minimize a specific loss function or maximize a certain objective. The system can continue to train the neural network 1926 by adjusting parameters based on the output of the validation, refinement, or retraining block 1812, and rerun the prediction 1810 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1926 even after deployment 1814 of the neural network 1926. The neural network 1926 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1910, the trained machine-learning program 1902 uses the features 1906 for analyzing query data 1928 to generate inferences, outcomes, or predictions, as examples of a prediction/inference data 1922. For example, during prediction phase 1910, the trained machine-learning program 1902 is used to generate an output. Query data 1928 is provided as an input to the trained machine-learning program 1902, and the trained machine-learning program 1902 generates the prediction/inference data 1922 as output, responsive to receipt of the query data 1928. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1902 may be a generative AI model. Generative AI is a term that may refer to any type of artificial intelligence that can create new content from training data 1904. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1922 that is output include trend assessment and predictions, translations, summaries, image or video recognition and categorization, natural language processing, face recognition, user sentiment assessments, advertisement targeting and optimization, voice recognition, or media content generation, recommendation, and personalization.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: accessing a particular geographic location for a first user; accessing map data for the particular geographic location; identifying that a pet avatar for a second user is associated with the particular geographic location; causing display, on a first computing device of the first user, of: the particular geographic location using the map data; the pet avatar; and an interface element configured to feed the pet avatar; receiving a user selection of the interface element from the first user; causing display, on the first computing device for the first user, of an indication of the pet avatar being fed corresponding to the interface element; and transmitting a notification to a second computing device of the second user including an indication that the pet avatar is being fed corresponding to the interface element.

In Example 2, the subject matter of Example 1 includes, inputting a prompt into a machine learning model to generate the pet avatar, the machine learning model trained to receive prompts indicative of pet characteristics, and generating pet avatars in response to receiving the prompts.

In Example 3, the subject matter of Example 2 includes, wherein the prompt is based on input received from the second user, the input indicating one or more desired characteristics for the pet avatar.

In Example 4, the subject matter of Examples 2-3 includes, wherein the prompt is based on input received from the second user, the input indicating one or more personality traits for the pet avatar, the machine learning model generating animation for the pet avatar that corresponds to the one or more personality traits for the pet avatar.

In Example 5, the subject matter of Examples 2-4 includes, wherein the prompt is automatically generated based on an identity graph of the second user based on the second user's use of one or more interaction functions.

In Example 6, the subject matter of Examples 2-5 includes, wherein the machine learning model includes a stable diffusion model that applies noise to generate the pet avatar.

In Example 7, the subject matter of Examples 1-6 includes, wherein accessing the particular geographic location for the first user includes identifying a current location of the first user based on global positioning system data of a computing device associated with the first user.

In Example 8, the subject matter of Examples 1-7 includes, wherein identifying that the pet avatar for the second user is associated with the particular geographic location includes identifying all pet avatars within a specific area around the geographic location.

In Example 9, the subject matter of Example 8 includes, wherein the specific area includes around a specific radius.

In Example 10, the subject matter of Examples 8-9 includes, wherein the specific area includes an area defined for a particular event.

In Example 11, the subject matter of Examples 1-10 includes, wherein identifying that the pet avatar for the second user is associated with the particular geographic location includes identifying all pet avatars within a specific radius around the geographic location.

In Example 12, the subject matter of Examples 1-11 includes, accessing calendar schedule information for the second user and identifying a location corresponding to an event of the user's calendar schedule information when the first user is accessing the particular geographic location, wherein identifying that the pet avatar for the second user is associated with the particular geographic location includes determining that the location is within the particular geographic location.

In Example 13, the subject matter of Examples 1-12 includes, wherein identifying that the pet avatar for the second user is associated with the particular geographic location includes determining that a home location for the second user is with the geographic location.

In Example 14, the subject matter of Examples 1-13 includes, wherein identifying that the pet avatar for the second user is associated with the particular geographic location includes determining that a location of a post created by the second user in the past is with the geographic location.

In Example 15, the subject matter of Examples 1-14 includes, wherein causing display of the indication of the pet avatar being fed corresponding to the interface element comprises causing display of an animation of the pet avatar eating food corresponding to the interface element.

In Example 16, the subject matter of Examples 1-15 includes, wherein causing display of the particular geographic location using the map data, the pet avatar, and the interface element configured to feed the pet avatar further comprises causing display of a first interface element corresponding to a first type of food, and a second interface element corresponding to a second type of food, the first and second interface elements displayed above a head of the pet avatar, wherein in response to a user selection of the first interface element, causing display of the pet avatar eating a first type of food corresponding to the first interface element, in response to a user selection of the second interface element, causing display of the pet avatar eating a second type of food corresponding to the second interface element.

In Example 17, the subject matter of Examples 1-16 includes, inputting the pet avatar and food corresponding to the interface element into a generative machine learning model, the generative machine learning model trained to generate updated pet avatars from food fed to the pet avatars; receiving a transformed pet avatar for the second user from the generative machine learning model, the transformed pet avatar indicative of a transformation in response to feeding the food to the pet avatar; and updating the pet avatar of the second user to the transformed pet avatar, wherein the transmitted notification includes the transformed pet avatar.

In Example 18, the subject matter of Examples 1-17 includes, wherein the indication of the pet avatar being fed includes stretching or squashing the pet avatar on display.

Example 19 is a method comprising: accessing a particular geographic location for a first user; accessing map data for the particular geographic location; identifying that a pet avatar for a second user is associated with the particular geographic location; causing display, on a first computing device of the first user, of: the particular geographic location using the map data; the pet avatar; and an interface element configured to feed the pet avatar; receiving a user selection of the interface element from the first user; causing display, on the first computing device for the first user, of an indication of the pet avatar being fed corresponding to the interface element; and transmitting a notification to a second computing device of the second user including an indication that the pet avatar is being fed corresponding to the interface element.

Example 20 is a non-transitory computer-readable storage medium storing instructions that, when executed by at least one processor, cause the at least one processor to perform operations comprising: accessing a particular geographic location for a first user; accessing map data for the particular geographic location; identifying that a pet avatar for a second user is associated with the particular geographic location; causing display, on a first computing device of the first user, of: the particular geographic location using the map data; the pet avatar; and an interface element configured to feed the pet avatar; receiving a user selection of the interface element from the first user; causing display, on the first computing device for the first user, of an indication of the pet avatar being fed corresponding to the interface element; and transmitting a notification to a second computing device of the second user including an indication that the pet avatar is being fed corresponding to the interface element.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi®network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

### CONCLUSION

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
accessing a particular geographic location for a first user;
accessing map data for the particular geographic location;
identifying that a pet avatar for a second user is associated with the particular geographic location;
causing display, on a first computing device of the first user, of:
the particular geographic location using the map data;
the pet avatar; and
an interface element configured to feed the pet avatar;
receiving a user selection of the interface element from the first user;
causing display, on the first computing device for the first user, of an indication of the pet avatar being fed corresponding to the interface element; and
transmitting a notification to a second computing device of the second user including an indication that the pet avatar is being fed corresponding to the interface element.

2. The system of claim 1, further comprising:
inputting a prompt into a machine learning model to generate the pet avatar, the machine learning model trained to receive prompts indicative of pet characteristics, and generating pet avatars in response to receiving the prompts.

3. The system of claim 2, wherein the prompt is based on input received from the second user, the input indicating one or more desired characteristics for the pet avatar.

4. The system of claim 2, wherein the prompt is based on input received from the second user, the input indicating one or more personality traits for the pet avatar, the machine learning model generating animation for the pet avatar that corresponds to the one or more personality traits for the pet avatar.

5. The system of claim 2, wherein the prompt is automatically generated based on an identity graph of the second user based on the second user's use of one or more interaction functions.

6. The system of claim 2, wherein the machine learning model includes a stable diffusion model that applies noise to generate the pet avatar.

7. The system of claim 1, wherein accessing the particular geographic location for the first user includes identifying a current location of the first user based on global positioning system data of a computing device associated with the first user.

8. The system of claim 1, wherein identifying that the pet avatar for the second user is associated with the particular geographic location includes identifying all pet avatars within a specific area around the geographic location.

9. The system of claim 8, wherein the specific area includes around a specific radius.

10. The system of claim 8, wherein the specific area includes an area defined for a particular event.

11. The system of claim 1, wherein identifying that the pet avatar for the second user is associated with the particular geographic location includes identifying all pet avatars within a specific radius around the geographic location.

12. The system of claim 1, further comprising accessing calendar schedule information for the second user and identifying a location corresponding to an event of the user's calendar schedule information when the first user is accessing the particular geographic location, wherein identifying that the pet avatar for the second user is associated with the particular geographic location includes determining that the location is within the particular geographic location.

13. The system of claim 1, wherein identifying that the pet avatar for the second user is associated with the particular geographic location includes determining that a home location for the second user is with the geographic location.

14. The system of claim 1, wherein identifying that the pet avatar for the second user is associated with the particular geographic location includes determining that a location of a post created by the second user in the past is with the geographic location.

15. The system of claim 1, wherein causing display of the indication of the pet avatar being fed corresponding to the interface element comprises causing display of an animation of the pet avatar eating food corresponding to the interface element.

16. The system of claim 1, wherein causing display of the particular geographic location using the map data, the pet avatar, and the interface element configured to feed the pet avatar further comprises causing display of a first interface element corresponding to a first type of food, and a second interface element corresponding to a second type of food, the first and second interface elements displayed above a head of the pet avatar, wherein in response to a user selection of the first interface element, causing display of the pet avatar eating a first type of food corresponding to the first interface element, in response to a user selection of the second interface element, causing display of the pet avatar eating a second type of food corresponding to the second interface element.

17. The system of claim 1, further comprising:
inputting the pet avatar and food corresponding to the interface element into a generative machine learning model, the generative machine learning model trained to generate updated pet avatars from food fed to the pet avatars;
receiving a transformed pet avatar for the second user from the generative machine learning model, the transformed pet avatar indicative of a transformation in response to feeding the food to the pet avatar; and
updating the pet avatar of the second user to the transformed pet avatar, wherein the transmitted notification includes the transformed pet avatar.

18. The system of claim 1, wherein the indication of the pet avatar being fed includes stretching or squashing the pet avatar on display.

19. A method comprising:
accessing a particular geographic location for a first user;
accessing map data for the particular geographic location;
identifying that a pet avatar for a second user is associated with the particular geographic location;
causing display, on a first computing device of the first user, of:
the particular geographic location using the map data;
the pet avatar; and
an interface element configured to feed the pet avatar;
receiving a user selection of the interface element from the first user;
causing display, on the first computing device for the first user, of an indication of the pet avatar being fed corresponding to the interface element; and
transmitting a notification to a second computing device of the second user including an indication that the pet avatar is being fed corresponding to the interface element.

20. A non-transitory computer-readable storage medium storing instructions that, when executed by at least one processor, cause the at least one processor to perform operations comprising:
accessing a particular geographic location for a first user;
accessing map data for the particular geographic location;
identifying that a pet avatar for a second user is associated with the particular geographic location;
causing display, on a first computing device of the first user, of:
the particular geographic location using the map data;
the pet avatar; and
an interface element configured to feed the pet avatar;
receiving a user selection of the interface element from the first user;
causing display, on the first computing device for the first user, of an indication of the pet avatar being fed corresponding to the interface element; and
transmitting a notification to a second computing device of the second user including an indication that the pet avatar is being fed corresponding to the interface element.
